(19) United States
(12) Patent Application Publication
(10) Pub. No.: US 2019/0351914 A1
(43) Pub. Date: Nov. 21, 2019

(54) SYSTEM AND METHOD FOR IDENTIFYING SUSPICIOUS POINTS IN DRIVING RECORDS AND IMPROVING DRIVING

(71) Applicant: Pony.ai, Inc., Fremont, CA (US)

(72) Inventors: Xiang Yu, Santa Clara, CA (US); Hao Song, Sunnyvale, CA (US); Sinan Xiao, Mountain View, CA (US); Jie Hou, Fremont, CA (US); Tiancheng Lou, Milpitas, CA (US); Jun Peng, Fremont, CA (US)

(21) Appl. No.: 15/980,594

(22) Filed: May 15, 2018

(51) Int. Cl. B60W 50/04; G07C 5/08

(52) U.S. Cl. CPC B60W 50/04; G07C 5/0841; B60W 2420/52; B60W 2550/10; B60W 2520/105; B60W 2510/18; B60W 2510/20; B60W 2420/42

(57) ABSTRACT

Systems, methods, and non-transitory computer-readable media are provided for acquiring driving records from an autonomous vehicle. One or more patterns can be determined from the driving records. One or more criteria can be generated based on the one or more patterns. One or more suspicious points can be identified in the driving records by applying the one or more criteria to the driving records.

### FIELD OF THE INVENTION

This disclosure relates to identifying potential flaws in a historic driving record (suspicious points) of an autonomous vehicle. More particularly, this disclosure relates to techniques for identifying suspicious points based on one or more patterns in the data. Once the suspicious points are identified, the driving instructions can be revised and then tested with the driving record to confirm that the flaws have been fixed.

### BACKGROUND

In general, an autonomous vehicle is controlled by machine-readable instructions embedded in one or more computing systems onboard the autonomous vehicle. The autonomous vehicle can dynamically respond (e.g., accelerate, brake, stop, turn right, turn left, etc.) to changing road conditions based on inputs received from various sensor systems (e.g., LiDAR systems, radar systems, camera systems, etc.). For example, if an autonomous vehicle is approaching an intersection with a red light, the autonomous vehicle can detect the red light, and gradually apply brakes until the autonomous vehicle comes to a complete stop. During development cycles of an autonomous vehicle, issues associated with machine-readable instructions (e.g., firmware and/or software bugs), often times, do not manifest until the machine-readable instructions are deployed and are under test in the autonomous vehicle. Moreover, the machine-readable instructions are typically developed under ideal conditions and assumptions, thus, in real-life, where the conditions are far from ideal, the autonomous vehicle might not respond or react in ways contemplated by personnel who programmed or configured the machine-readable instructions.

### SUMMARY

Various embodiments of the present disclosure can include systems, methods, and non-transitory computer readable media configured to acquiring driving records from an autonomous vehicle. One or more patterns can be determined from the driving records. One or more criteria can be generated based on the one or more patterns. One or more suspicious points can be identified in the driving records by applying the one or more criteria to the driving records.

In some embodiments, data in the driving records corresponding to the one or more suspicious points can be retrieved. The one or more suspicious points can be simulated in a virtual environment, with a simulated autonomous vehicle, based on the data in the driving records.

In some embodiments, the driving records can include data from at least one of light detection and ranging systems, radar systems, or camera systems of the autonomous vehicle.

In some embodiments, the driving records can include data from at least one of location, speed, acceleration, rotation angle, throttle pedal percentage, brake pedal percentage, steering angle, trajectory planned, or obstacle perceived data from the autonomous vehicle.

In some embodiments, the driving records can be acquired hourly, daily, weekly, bi-weekly, monthly, or at an end of a driving session from the autonomous vehicle.

In some embodiments, the one or more patterns can be identified from the driving records by utilizing regression analysis. The one or more patterns can be identified from the driving records by utilizing statistical analysis.

In some embodiments, the one or more criteria can be generated based on upper limit values of the one or more patterns.

In some embodiments, the one or more criteria can be generated applying a tolerance to upper limit values of the one or more patterns.

In some embodiments, the driving records acquired from the autonomous vehicle can be aggregated. Data points can be identified in the aggregated driving records that satisfy the one or more criteria. The data points can be labeled as the one or more suspicious points.

In some embodiments, a user selection of a time frame can be received to encapsulate the data in the driving records centered about the one or more suspicious points. The data can be retrieved from the driving records corresponding to the time frame.

In some embodiments, the time frame to encapsulate the data can be a default time frame.

In some embodiments, the user selection of the time frame to encapsulate the data can include any increments of seconds, minutes, and hours.

These and other features of the systems, methods, and non-transitory computer readable media disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for purposes of illustration and description only and are not intended as a definition of the limits of the invention.

### BRIEF DESCRIPTION OF THE DRAWINGS

Certain features of various embodiments of the present technology are set forth with particularity in the appended claims. A better understanding of the features and advantages of the technology will be obtained by reference to the following detailed description that sets forth illustrative embodiments, in which the principles of the invention are utilized, and the accompanying drawings of which:

FIG. 1 illustrates an example autonomous vehicle, according to an embodiment of the present disclosure.

FIG. 2 illustrates an example autonomous vehicle control system, according to an embodiment of the present disclosure.

FIG. 3A illustrates an example framework development environment, according to an embodiment of the present disclosure.

FIG. 3B illustrates an example data analysis, according to an embodiment of the present disclosure.

FIG. 4 illustrates an example framework development scenario, according to an embodiment of the present disclosure.

FIG. 5 illustrates an example method, according to an embodiment of the present disclosure.

FIG. 6 illustrates a block diagram of a computer system.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION

An autonomous vehicle is equipped with a complex set of sensors, data acquisition systems, actuation systems, and computing systems to allow the autonomous vehicle to drive autonomously (e.g., without human involvement) on roads. The autonomous vehicle is controlled by machine-readable instructions embedded in one or more computing systems and/or one or more data acquisition systems onboard the autonomous vehicle. The machine-readable instructions can, in concert with the one or more computing systems and/or the one or more data acquisition systems, receive inputs from various sensor systems (e.g., LiDAR systems, radar systems, camera systems, etc.) and output responses to one or more actuation systems based on the inputs. The autonomous vehicle can dynamically respond (e.g., accelerate, brake, stop, turn right, turn left, etc.) to changing input conditions. In general, machine-readable instructions of an autonomous vehicle, are, in part, implementations of various algorithms (e.g., control algorithms, machine learning algorithms, data analysis and visualization algorithms, etc.) with fine-tuned parameters that are associated with operating the autonomous vehicle. During development cycles of an autonomous vehicle, issues associated with machine-readable instructions (e.g., firmware and/or software bugs), often times, go undetected or unnoticed because the machine-readable instructions are developed, tuned, and tested under ideal conditions and assumptions. These issues, therefore, tend not to surface until the machine-readable instructions are deployed and are under test in the autonomous vehicle.

Under conventional approaches, machine-readable instructions of an autonomous vehicle must undergo thousands and thousands, if not millions and millions, of hours of real-life testing (e.g., real-world driving) in order to account for most driving scenarios or conditions and to uncover any issues in the machine-readable instructions. This laborious process is additive to the already countless time spent on developing, improving, and refining the machine-readable instructions in a laboratory setting. Even then, the machine-readable instructions of the autonomous vehicle need to be continuously monitored, refined, and improved as more and more real-world driving data become available.

Moreover, conventional approaches to investigate vehicle anomalies can be taxing. For instance, a lot of man-hours are spent on analyzing corpus of driving records to look for anomalies. If the driving records include images or videos, for example, the driving records need to be evaluated a frame at a time or on a frame-by-frame basis. In addition, additional man-hours are spent on looking into operational states of the autonomous vehicle (e.g., velocity, accelerations, direction, etc.) at the time of the anomalies to corroborate the driving records and the operational states, with the anomalies. As such, conventional approaches to testing or improving machine-readable instructions of an autonomous vehicle can be time consuming, costly, frustrating, inefficient, ineffective, and cumbersome.

A claimed solution rooted in computer technology overcomes problems specifically arising in the realm of automobile technology and computer technology. In various embodiments, systems, methods, and non-transitory computer readable media can be configured to acquire driving records from an autonomous vehicle. The records can be aggregated to identify patterns to generate analysis baseline or metrics. Such baselines or metrics can then be applied on the records to find singularities or suspicious points. Once the singularities or suspicious points are identified, they can be analyzed and the analysis can inform and enable improvement of the driving instructions which are then tested in a simulated environment before rolling out to the test vehicles.

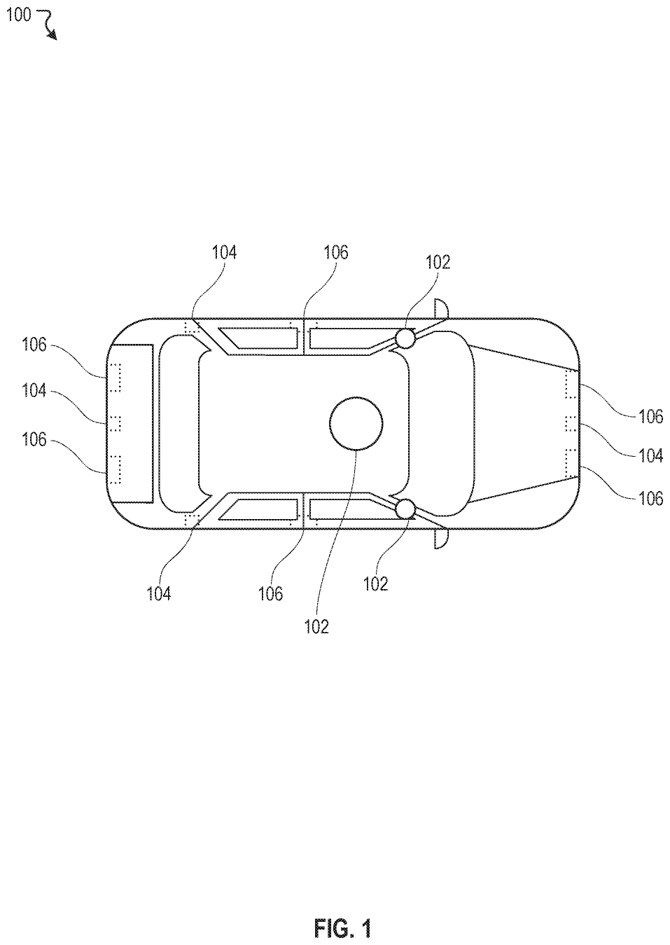

FIG. 1 illustrates an example autonomous vehicle 100, according to an embodiment of the present disclosure. An autonomous vehicle generally refers to a category of vehicles that are capable of sensing and driving in an environment by itself. The autonomous vehicle 100 can include a myriad of sensors (e.g., camera, radar, LiDAR, etc.) to detect and identify objects in an environment. Such objects may include, but not limited to, pedestrians, road signs, traffic lights, and/or other vehicles, for example. The autonomous vehicle 100 can also include a myriad actuators to propel the autonomous vehicle 100 navigate around the environment. Such actuators may include, for example, any suitable electro-mechanical devices or systems to control throttle response, braking action, steering action, etc. In some embodiments, the autonomous vehicle 100 can recognize, interpret, and comprehend road signs (e.g., speed limit, school zone, construction zone, etc.) and traffic lights (e.g., red light, yellow light, green light, flashing red light, etc.). For example, the autonomous vehicle 100 can adjust vehicle speed based on speed limit signs posted on roadways. In some embodiments, the autonomous vehicle 100 can determine and adjust a speed at which the autonomous vehicle 100 is traveling in relation to other objects in the environment. For example, the autonomous vehicle 100 can maintain a constant, safe distance from a vehicle ahead (e.g., adaptive cruise control). In this example, the autonomous vehicle 100 maintains this safe distance by constantly adjusting its vehicle speed to that of the vehicle ahead.

In various embodiments, the autonomous vehicle 100 may navigate through roads, streets, and/or terrain with limited or no human input. The word “vehicle” or “vehicles” as used in this paper includes vehicles that travel on ground (e.g., cars, trucks, bus, etc.), but may also include vehicles that travel in air (e.g., drones, airplanes, helicopters, etc.), vehicles that travel on water (e.g., boats, submarines, etc.). Further, “vehicle” or “vehicles” discussed in this paper may or may not accommodate one or more passengers therein.

In general, the autonomous vehicle 100 can effectuate any control to itself that a human driver can on a conventional vehicle. For example, the autonomous vehicle 100 can accelerate, brake, turn left or right, or drive in a reverse direction just as a human driver can on a conventional vehicle. The autonomous vehicle 100 can also sense environmental conditions, gauge spatial relationships (e.g., distances between objects and itself), detect and analyze road signs just as the human driver. Moreover, the autonomous vehicle 100 can perform more complex operations, such as parallel parking, parking in a crowded parking lot, collision avoidance, etc., without any human input.

In various embodiments, the autonomous vehicle 100 may include one or more sensors. As used herein, the one or more sensors may include laser scanning systems (e.g., LiDARs) 102, radar systems 104, camera systems 106, and/or the like. The one or more sensors allow the autonomous vehicle 100 to sense an environment around the autonomous vehicle 100. For example, the LiDARs 102 can generate a three dimensional map of the environment. The LiDARs 102 can also detect objects in the environment. In another example, the radar systems 104 can determine distances and speeds of objects around the autonomous vehicle 100. In another example, the camera systems 106 can capture and process image data to detect and identify objects, such as road signs, as well as deciphering content of the objects, such as speed limit posted on the road signs.

In the example of FIG. 1, the autonomous vehicle 100 is shown with three LiDARs 102. One LiDAR is coupled to a roof or a top of the autonomous vehicle 100 and two LiDARs are coupled to A-pillars of the autonomous vehicle 100. As discussed, LiDARs can be configured to generate three dimensional maps of an environment. In the example of FIG. 1, the autonomous vehicle 100 is shown with four radar systems 104. Two radar systems are coupled to a front-side and a back-side of the autonomous vehicle 100, and two radar systems are coupled to a right-side and a left-side of the autonomous vehicle 100. In some embodiments, the front-side and the back-side radar systems can be configured for adaptive cruise control and/or accident avoidance. For example, the front-side radar system can be used by the autonomous vehicle 100 to maintain a healthy distance from a vehicle ahead of the autonomous vehicle 100. In another example, if the vehicle ahead experiences a suddenly reduction in speed, the autonomous vehicle 100 can detect this sudden change in motion and adjust its vehicle speed accordingly. In some embodiments, the right-side and the left-side radar systems can be configured for blind-spot detection. In the example of FIG. 1, the autonomous vehicle 100 is shown with six camera systems 106. Two camera systems are coupled to the front-side of the autonomous vehicle 100, two camera systems are coupled to the back-side of the autonomous vehicle 100, and two camera systems are couple to the right-side and the left-side of the autonomous vehicle 100. In some embodiments, the front-side and the back-side camera systems can be configured to detect, identify, and decipher objects, such as cars, pedestrian, road signs, in the front and the back of the autonomous vehicle 100. For example, the front-side camera systems can be utilized by the autonomous vehicle 100 to determine speed limits. In some embodiments, the right-side and the left-side camera systems can be configured to detect objects, such as lane markers. For example, side camera systems can be used by the autonomous vehicle 100 to ensure that the autonomous vehicle 100 drives within its lane.

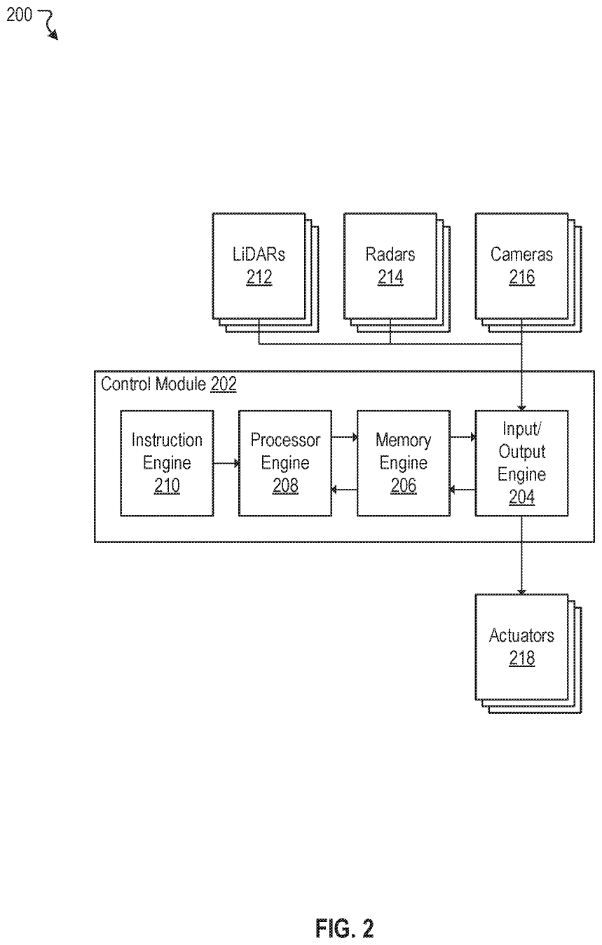

FIG. 2 illustrates an example autonomous vehicle control system 200, according to an embodiment of the present disclosure. In various embodiments, the autonomous vehicle control system 200 can include a control module 202, one or more LiDARs 212, one or more radars 214, one or more cameras 216, and one or more actuators 218. The one or more LiDARs 212, the one or more radars 214, and the one or more cameras 216 can be coupled to inputs of the control module 202. The one or more actuators 218 can be coupled to outputs of the control module 202. As discussed, the one or more LiDARs 212 can be configured to output three dimensional mapping data (e.g., point cloud data) to the control module 202. The one or more radars 214 can output distance and speed data of objects to the control module 202. The one or more cameras 216 can output image data to the control module 202. In some embodiments, the control module 202 can be configured to process various data acquired or obtained from the one or more LiDARs 212, the one or more radars 214, and the one or more cameras 216, make driving decisions (e.g., accelerate, brake, maintain current speed, turn right, turn left, yield, etc.) based on these processed data, and output one or more responses (e.g., actions to be taken by an autonomous vehicle) to the one or more actuators 218. In general, the one or more actuator 218 may be any electro or electro-mechanical devices or systems that enable an autonomous vehicle to take physical actions (e.g., throttle control, brake control, steering control, etc.) responsive to input changes. In some embodiments, the autonomous vehicle 100 in FIG. 1 can be controlled by the autonomous vehicle control system 200 of FIG. 2. Although in the example of FIG. 2, only one control module (e.g., the control module 202) is depicted, the autonomous vehicle control system 200 is not limited to just one such control module. In some embodiments, the autonomous vehicle control system 200 can include multiple control modules. For example, there can be a control module for each one of the sensors. Many variations are possible.

In some embodiments, the control module 202 can further include an input/output engine 204, a memory engine 206, a processor engine 208, and an instruction engine 210. The input/output engine 204 can be configured to interface with the inputs and the outputs of the control module 202. For example, the input/output engine 204 can be coupled to the one or more LiDARs 212, the one or more radars 214, and the one or more cameras 216 to acquire or obtain data from these sensors or sensor systems. The acquired data can be stored in the memory engine 206 to be later accessed by the processor engine 208. The input/output module 204 can also be coupled to the one or more actuators 218 to transmit control signals from the processor engine 208, via the memory engine 206, to the one or more actuators 218. In some embodiments, the memory engine 206 facilitates data transfer and data storage between the input/output engine 204 and the processor engine 208. In some embodiments, the processor engine 208 can be configured to process various data acquired from the inputs that are stored in the memory engine 206. For example, the processor engine 208 can process point cloud data acquired from the one or more LiDARs 212 to construct three dimensional maps of an environment. In another example, the processor engine 208 can process distance and speed data of objects in the environment obtained from the one or more radars 214 to determine their relative distances and speeds to an autonomous vehicle. In another example, the processor engine 208 can process image data from the one or more cameras 216 to detect, identify, and decipher objects captured in the image data. For instance, the processor engine 208 can, utilizing conventional imaging processing and object recognition/identification techniques, determine the objects captured in the image data are pedestrians, cyclists, moving vehicles, trees, road signs, etc. In some embodiments, the processor engine 208 can retrieve machine-readable instructions from the instruction engine 210 to process various data in accordance to various algorithms (e.g., control, machine learning, data analysis and visualization algorithms) embedded or stored in the instruction engine 210. For example, the processor engine 208, in conjunction with the instruction engine 210, can execute control algorithms tuned with specific control parameters to control the autonomous vehicle based on input conditions and in accordance to the control algorithms.

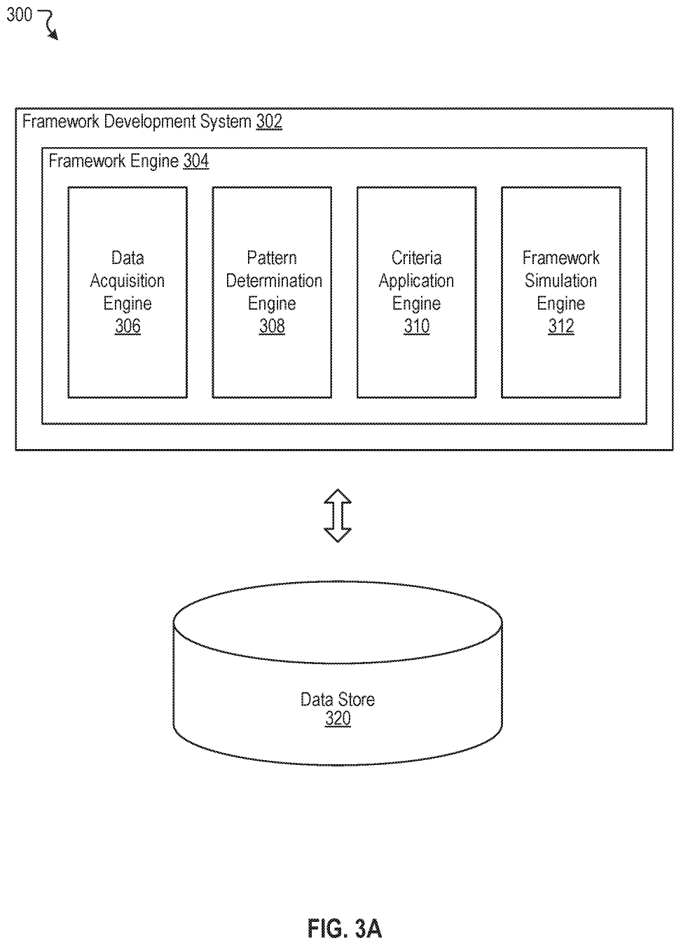

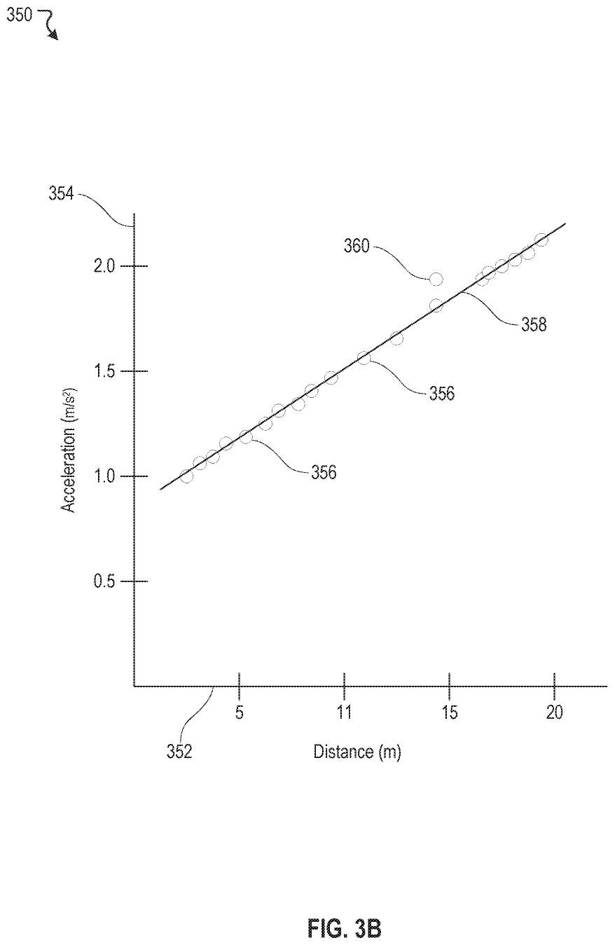

FIG. 3A illustrates an example framework development environment 300, according to an embodiment of the present disclosure. The framework development environment 300 can include at least one framework development system 302 that includes one or more processors and memory. The processors can be configured to perform various operations associated with framework development (e.g., development of machine-readable instructions). In general, the framework development system 302 can be configured to verify and validate algorithms embedded in machine-readable instructions of an autonomous vehicle using the processer(s) and memory. As shown in FIG. 3A, in some embodiments, the framework development system 302 can include a framework engine 304. The framework engine 304 can further include a data acquisition engine 306, a pattern determination engine 308, a criteria application engine 310 and a framework simulation engine 312. In some embodiments, the example framework development environment 300 may also include at least one data store 320 that is accessible to the framework development system 302. In some embodiments, the data store 320 can be configured to store parameters, data, or binary or machine-readable codes of the data acquisition engine 306, the pattern determination engine 308, the criteria application engine 310 and the framework simulation engine 312.

As discussed, machine-readable instructions (e.g., a framework) of an autonomous vehicle must undergo rigorous testing prior to its deployment into the autonomous vehicle for real-life testing (e.g., real-world driving). Any issues associated with the machine-readable instructions that arise during real-life testing must be understood, corrected, updated, and tested prior to its redeployment for further testing. In general, during testing of an autonomous vehicle, one or more passengers may be present in the autonomous vehicle to make note, perceive, or observe any anomalous (or suspicious) behaviors, activities, or events associated with the autonomous vehicle while the vehicle is driving. For example, the autonomous vehicle may have accelerated more vigorously from a stop than before, on a same route, under similar environmental conditions, and for no apparent or obvious reasons. In this example, the one or more passengers of the autonomous vehicle may flag the time and date of such incident so driving data can be later reviewed by appropriate personnel. In another example, the autonomous vehicle may have slowed unnecessarily, on a same route, under similar environmental conditions, and for no apparent or obvious reasons. Again, the one or more passengers of the autonomous vehicle may flag the time and date of such incident. In some instances, there may be a clicking device available for the one or more passengers to timestamp or document any anomalous (or suspicious) events perceived. The clicking device creates timestamps or marks on the driving data collected by the autonomous vehicle. These timestamps or flags allow appropriate personnel to quickly refer to the driving data associated with the anomalous (or suspicious) events. In some cases, the passengers and the personnel can be one of same person or people.

There may be incidents in which the one or more passengers might not be even aware, perceive, nor observe that an anomalous or a suspicious event occurred. In such cases, the framework development system 302 may be utilized to automatically identify one or more anomalous or suspicious events associated with autonomous vehicles. In various embodiments, the framework engine 304 can acquire driving records from an autonomous vehicle. The framework engine 304 can analyze the driving records to determine one or more patterns correlated with “normal” driving behaviors. The normal driving behavior can also be reflected in baselines and metrics extracted from the driving records. The baselines or metrics can be applied to the driving record to detect anomalies (or singularities or suspicious points). The baselines and metrics can also be transformed to criteria which also can be used to identify one or more suspicious points in the driving records. Depending on the nature of the suspicious points identified, machine-readable instructions of the autonomous vehicle may or may not be updated.

If updated, the framework engine 304 can create a simulated test case to test the updated machine-readable instructions in a safe, simulated virtual environment.

In some embodiments, the data acquisition engine 306 can be configured to routinely acquire or obtain driving history, driving log, and/or data (e.g., driving records) from an autonomous vehicle. The data acquisition engine 306 can be coupled to the autonomous vehicle to acquire driving records. In one embodiment, the data acquisition engine 306 can acquire or obtain driving records from the autonomous vehicle at a predetermined time period. For example, the data acquisition engine 306 provides users with an option to acquire or obtain driving records from the autonomous vehicle hourly, daily, weekly, bi-weekly, monthly, or any other suitable time period. In another embodiment, the data acquisition engine 306 can acquire or obtain all driving records from the autonomous vehicle after a driving session ends.

In various embodiments, the driving records may include vehicle operational data such as location data, speed data, acceleration data, rotational angle data, throttle pedal percentage data, brake pedal percentage data, steering angle data, trajectory planning data, and obstacle perception data collected by an autonomous vehicle while in a driving mode. The location data contain location coordinate information expressed in latitudes and longitudes. In some cases, the location coordinate information can be expressed in Cartesian coordinates (e.g., x-y-z coordinates). The location data can be used to reconstruct or recreate routes that the autonomous vehicle traveled. The speed data contain various speed information of the autonomous vehicle while in the driving mode. The speed data can include instantaneous speeds and/or an average speed over some time. In some embodiments, the average speed over some time are user selectable. For example, a user can select to view an average speed over an hour or an average speed over two hours. The acceleration data contain acceleration information of the autonomous vehicle while in the driving mode. The acceleration data can include both instantaneous accelerations and/or average acceleration over some time. In some embodiments, the average acceleration over some time are user selectable. For example, a user can select to view an average acceleration over an hour or an average acceleration over two hours. The rotational angle data contain rotational information of the autonomous vehicle (e.g., right turn, left turn, forwards, backwards, east, west, north, south, etc.) as well as its corresponding angular information (e.g., a 90 degrees right turn, a 30 degrees right turn, etc.) while in the driving mode.

The rotational angle data can be used to determine directions that the autonomous vehicle traveled. The throttle pedal percentage data contain information regarding depths of a throttle pedal (e.g., acceleration pedal or gas pedal) pressed to move the autonomous vehicle forwards or backwards. For example, the throttle pedal pressed halfway of its full travel range corresponds to a throttle pedal percentage data of 50 percent. The throttle pedal percentage data can be used to correlate the speed data and the acceleration data collect by the autonomous vehicle. The brake pedal percentage data contain information regarding depths of a brake pedal pressed to slowdown the autonomous vehicle. For example, the brake pedal pressed halfway of its full travel range corresponds to a brake pedal percentage data of 50 percent. The brake pedal percentage data can be used to correlate the speed data and the acceleration data (deceleration) collect by the autonomous vehicle. The steering angle data contain information regarding number of turns or revolutions a steering wheel rotated to change directions of the autonomous car. The steering angle data can be used to correlate the rotational angle data. The trajectory planned data contain information regarding the autonomous vehicle's decisions in plotting a trajectory or a next trajectory. This information can be utilized to determine a next course of action that the autonomous vehicle is going to commit. The obstacle perceived data contain information regarding how objects are perceived and identified by the autonomous vehicle. The obstacle perceived data can include detecting objects, developing a contextual understanding between the objects, and understanding contents of the objects. In some embodiments, the driving records may also include data acquired from LiDARs, radar systems, and camera systems onboard the autonomous vehicle. For example, the data acquisition engine 306 can acquire point cloud data from the LiDARs.

In some embodiments, the data acquisition engine 306 can store the driving records acquired from the autonomous vehicle to the data store 320. The driving records may be later accessed by the pattern determination engine 308, criteria application engine 310, and/or the framework simulation engine 312 for further processing.

In some embodiments, the pattern determination engine 308 can be configured to perform data analysis on driving records acquired or obtained from an autonomous vehicle. The pattern determination engine 308 can interact with the data acquisition engine 306 and/or the data store 320 to access data in the driving records. The pattern determination engine 308 may aggregate driving records and perform data analysis on the aggregated driving records to determine one or more patterns that are consistent with “normal” driving behavior. In some embodiments, the pattern determination engine 308 can generate one or more criteria to identify suspicious points based on the one or more patterns. The one or more criteria may be based on upper limit values of the one or more patterns. For example, the pattern determination engine 308, by analyzing driving records, may identify a pattern that when an autonomous vehicle accelerates after a complete stop, the autonomous vehicle typically accelerates at a rate between 0.8 to 1.8 m/s² for the first 15 meters. In this example, the pattern determination engine 308 may automatically generate a criterion or a metric that if the autonomous vehicles accelerates, from a complete stop, at a rate greater than 1.8 m/s² for the first 15 meters, this event is a suspicious point and needs to be looked at by appropriate personnel. In some embodiments, the pattern determination engine 308 can automatically apply a default tolerance to an upper limit value of an identified pattern to create a criterion. For example, the pattern determination engine 308 may apply a default tolerance of +1-10% to an identified pattern. For instance, continuing from the example above, if a pattern of an autonomous vehicle is found to be an acceleration at a rate between 0.8 to 1.8 m/s² for the first 15 meters after a complete stop, the pattern determination engine 308 may automatically generate a corresponding criterion to be an acceleration of greater than 2.0 m/s² (or approximately 10% of 1.8 m/s²) for the first 15 meters after a complete stop. Many variations are possible.

In various embodiments, the pattern determination engine 308 can utilize various regression analysis methods to find patterns. For example, the various regression analysis methods may include, but not limited to, linear regression, simple regression, ordinary least squares, polynomial regression, and/or nonlinear regression models. In some embodiments, the pattern determination engine 308 can utilize statistical analysis methods to find patterns. The statistical analysis methods, for example, may include, but not limited to, time series analysis, variance analysis, mean square analysis, and/or data distribution models. In general, any suitable analysis methods understood by an ordinary person skilled in the art may be utilized to find patterns from a data set. Details of the pattern determination engine 308 are further discussed herein with reference to FIG. 3B.

In some embodiments, in addition to the automatically generated criteria, the pattern determination engine 308 can be configured to provide an option for a user to manually enter one or more criteria. For example, the user can define a criterion for a suspicious point as failure to signal before making a lane change. The user can manually enter this criterion into the pattern determination engine 308. In this example, if an autonomous vehicle fails to signal prior to a lane change, this event becomes a suspicious point. In some embodiments, the pattern determination engine 308 allows the user to override criteria that are automatically generated. For example, the automatically generated criterion that an acceleration, after a complete stop, at a rate greater than 2.0 m/s² for the first 15 meters might be too restrictive, sensitive, and/or flags too many false positives. In this example, upon a thorough investigation, the user may open up the criterion to be any acceleration, after a complete stop, at a rate greater than 2.3 m/s² for the first 15 meters. Many variations are possible.

In some embodiments, the one or more criteria generated by the pattern determination engine 308 can be accumulative. For example, one or more criteria are generated by the pattern determination engine 308 based on a first set of driving records. At some time later, a second set of driving records can be acquired and subsequently processed and analyzed by the pattern determination engine 308. In this example, the pattern determination engine 308, based on the second set of driving records, may update or modify the one or more criteria. For instance, a criterion that an acceleration, after a complete stop, at a rate greater than 1.8 m/s² for the first 15 meters was generated based on the first set of driving records. By analyzing new data obtained from the second set of driving records, the pattern determination engine 308 may update or modify the criterion to be an acceleration at a rate greater than 1.9 m/s² for the first 15 meters after a complete stop, for example.

As discussed, one or more criteria for identifying suspicious points may be automatically or manually generated. The one or more criteria can be any rules or metrics, or any combinations of the rules or metrics thereof, gained from performing data analysis on driving records of an autonomous vehicle. The one or more criteria may include some or all, but not limited, to the following:
Stopping at a stop sign for a time less than 3 seconds prior to an acceleration is a suspicious point.
Stopping for a time less than 2 seconds prior to making a right turn is a suspicious point.
Stopping at an intersection for a time less than 3 second before an acceleration after a traffic light turns from a red to a green light is a suspicious point.
Stopping at an intersection at a distance greater than 0.5 meters prior a line/marker demarcating the intersection is a suspicious point.
Accelerating, from a complete stop, at a rate greater than 1.8 m/s² for the first 15 meters is a suspicious point.
Failure to yield to a pedestrian, when making a left turn or a right turn, at an intersection is a suspicious point.
   Many variations are possible and many variations are contemplated. As discussed, details of the one or more criteria depend on outcomes from data analysis. This list is only intended to be illustrative of the types of criteria that can be generated by the pattern determination engine 308.

In some embodiments, the criteria application engine 310 applies the one or more criteria generated by the pattern determination engine 308 to driving records of an autonomous vehicle to identify one or more suspicious points. The criteria application engine 310 can interact with the data acquisition engine 306 and/or the data store 320 to access data in the driving records. The criteria application engine 310 can aggregate various data from the driving records and identify data points or locations in the aggregated driving records that meet or satisfy the one or more criteria. For example, a criterion that an acceleration, after a complete stop, at a rate greater than 1.8 m/s² for the first 15 meters was previously generated by the pattern determination engine 308. The criteria application engine 310 may find a data point in the driving records that corresponds to an acceleration of 1.9 m/s² for the first 15 meters after a complete stop. In this example, the criteria application engine 310 labels this data point as a suspicious point. Details of the criteria application engine 310 are further discussed herein with respect to FIG. 3B.

Once suspicious points are identified, in some embodiments, the criteria application engine 310 can be configured to retrieve data associated with the suspicious points from the driving records. For example, the criteria application engine 310 can retrieve or extract data from the driving records that are associated with a suspicious point. For instance, the criteria application engine 310 can interact with the data store 320 and/or the data acquisition engine 306 to retrieve or extract vehicle GPS location data, speed data, acceleration data, rotational angle data, throttle pedal percentage data, brake pedal percentage data, steering angle data, trajectory planning data, obstacle perception data, and as well as, data acquired from LiDARs, radar systems, and camera systems at the time of the suspicious point. In some embodiments, the criteria application engine 310 can be configured to allow a user to select a time frame to encapsulate data in the driving records centered about the suspicious point prior to data retrieval. For example, if a suspicious point has been identified to have occurred at 1:30 PM on a particular date, the criteria application engine 310 allows the user to retrieve data at +/−1 minute encapsulation about the suspicious point (e.g., from 1:29 PM to 1:31 PM). In another example, the criteria application engine 310 allows the user to retrieve data at +/−10 minutes encapsulation about the suspicious point (e.g., from 1:20 PM to 1:40 PM). In general, the criteria application engine 310 allows the user to select any suitable time frame encapsulation to retrieve data corresponding to suspicious points. In some embodiments, the criteria application engine 310 can default to a particular time frame encapsulation if no user selection is received. For example, the data application engine 310 defaults to retrieving data at +/−5 minutes encapsulation for any suspicious points identified.

After suspicious points are identified and data associated with the suspicious points are retrieved from driving records, appropriate personnel may look into the data to evaluate the circumstances that gave rise to the suspicious points. For example, an autonomous vehicle stopped a few meters before reaching an intersection has been identified as a suspicious point. The personnel, by studying image data captured from a front-side camera of the autonomous vehicle (e.g., the front-side cameras 106 of FIG. 1) at the time of the suspicious point, discovers that the autonomous car misinterpreted or misrecognized a faintly marked line as a line demarcating the intersection, and therefore, the autonomous vehicle stopped sooner than expected. The personnel, based on this observation, can modify object identification algorithms in machine readable instructions of the autonomous vehicle so that next time, if such circumstance were to arise again, the autonomous vehicle would ignore the faintly marked line and stop at a proper distance from the intersection.

Once the personnel determines an update is needed to the machine-readable instructions of the autonomous vehicle, the personnel modifies the machine-readable instructions to address the suspicious points previously identified. In some embodiments, the framework simulation engine 312 can be configured to validate the machine-readable instructions after updates or changes are incorporated. The framework simulation engine 312 runs through binary or machine-readable code to ensure the updates or changes made to the instructions meet its original design specification and its intended purpose. For example, the framework simulation engine 312 validates the updated machine-readable instructions to ensure the instructions are compatible with hardware (e.g., the control module 202 of FIG. 2) onboard the autonomous vehicle.

In some embodiments, the framework simulation engine 312 can be configured to simulate how the machine-readable instructions would respond or react in a simulated virtual environment. The framework simulation engine 312 can intake or ingest the validated machine-readable instructions, data from driving records associated with suspicious points, and recreate a virtual driving scenario that triggered the suspicious points. The framework simulation engine 312 allows personnel to study how a simulated autonomous vehicle responds to the suspicious points in accordance to the changes made to the machine-readable instructions. For example, continuing from the example above, the framework simulation engine 312 intakes the updated machine-readable instructions and the data associated with the suspicious point (e.g., stopping too soon on an intersection). In this example, the framework simulation engine 312 recreates a driving scenario in which the simulated autonomous vehicle, with the updated machine-readable instructions, approaches a simulated four-way intersection along with a simulated faintly marked line before the intersection. In this simulation, the personnel can make evaluations on the effectiveness of the updates made to the machine-readable instructions. As such, the effectiveness of the updates (e.g., firmware and/or software updates) in addressing the issues or bugs uncovered by the pattern determination engine 306 can be evaluated under a safe, simulated environment, rather than having to test the updated machine-readable instructions in an autonomous vehicle on road. Once machine-readable instructions are verified and tested (e.g., simulated), in some embodiments, the machine-readable instructions can be deployed (or redeployed) to the instruction engine 210 of FIG. 2 for further testing.

FIG. 3B illustrates an example data analysis 350, according to an embodiment of the present disclosure. This example analysis 350 corresponds to a linear regression analysis. In this example, an x-axis 352 represents distances traveled by an autonomous vehicle after a complete stop and a y-axis 354 represents accelerations by the autonomous vehicle after the complete stop. In this example, there can be a plurality of data points 356. Each data point represents an instantaneous acceleration from a complete stop measured at a distance travelled by the autonomous vehicle while accelerating. By performing the linear regression analysis, a line 358 can be fitted to the plurality of data points 356. From this linear regression analysis, one or more criteria can be generated. For example, a criterion can be an acceleration at a rate greater than 1.8 m/s² for the first 15 meters after a complete stop is a suspicious point. Once this criterion is generated, any data points that meet or satisfy this criterion is labeled as a suspicious point. In this example, a data point 360 meets or satisfies this criterion and, thus, is labeled as a suspicious point.

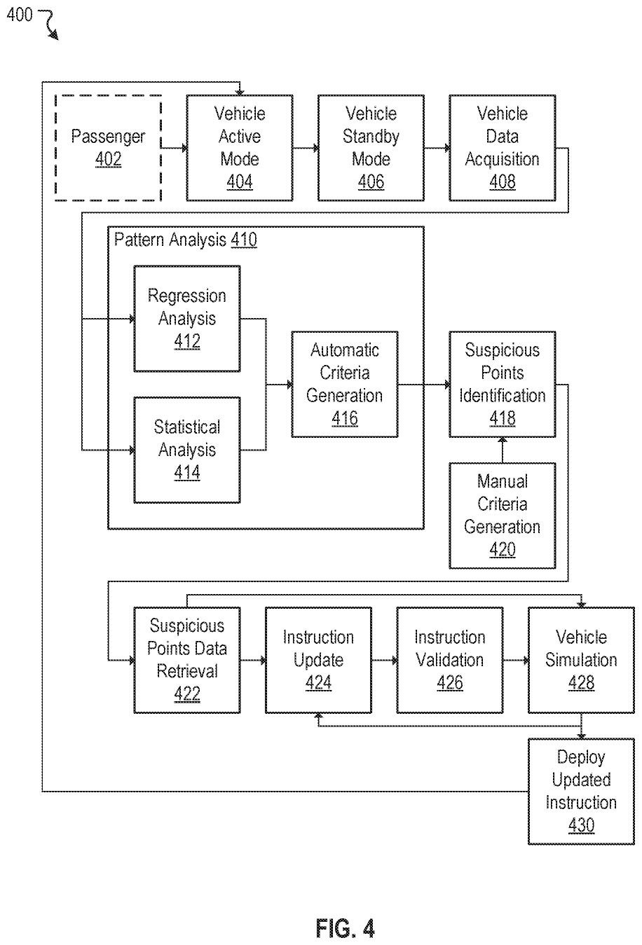

FIG. 4 illustrates an example framework development scenario 400, according to an embodiment of the present disclosure. In this example scenario 400, there can be a passenger 402. The passenger 402 may or may not be present in an autonomous vehicle. When present, the passenger 402 can make notes or observe any suspicious activity that the autonomous vehicle engages. In some embodiments, the autonomous vehicle may be in one of two modes. In a vehicle active mode 404, the autonomous vehicle engages in activities that are associated with driving. These activities include at least one of acceleration, braking, turn right, and turn left. While the autonomous vehicle is in the vehicle active mode 404, the autonomous vehicle collects, logs, and archives every second of data that are generated by the autonomous vehicle as driving records. In a vehicle standby mode 406, the autonomous vehicle engages in non-driving activities, such as diagnostic or power-off mode. When the autonomous vehicle is in the vehicle standby mode 406, data collected while the autonomous vehicle was last active can be acquired by a framework development system (e.g., the framework development system 302 of FIG. 3A). In this example, the framework development system can be coupled to the autonomous vehicle to acquire or download the driving records (vehicle data acquisition 408).

Once the driving records are acquired, the framework development system can perform various data analysis (regression analysis 412 and statistical analysis 414) on the driving records to identify patterns or “behaviors” exhibited by the autonomous vehicle (pattern analysis 410). From these patterns, one or more criteria (automatic criteria generation 416) for identifying suspicious points (suspicious points identification 418) can be generated by the framework development system. In some cases, personnel associated with framework development can manually generate one or more criteria (manual criteria generation 420) that can be used for identifying suspicious points (suspicious points identification 418).

The framework development system can also apply the one or more criteria, that are either automatically or manually generated, to the driving records to identify suspicious points (suspicious points identification 418) that the autonomous vehicle experienced while it was last active. Data points in the driving records are identified as suspicious points if the data points meet or satisfy the one or more criteria. The framework development system can retrieve data in the driving records that are associated with the suspicious points (suspicious points data retrieval 422). In some embodiments, a user can select a time period to encapsulate data centered around the suspicious points prior to data retrieval. In this example, personnel associated with framework development can evaluate the suspicious points and the data associated with the suspicious points. The personnel may or may not update or change machine-readable instructions in response to the suspicious points. When updates to the machine-readable instructions are warranted (instruction update 424), the personnel can utilize the framework development system to validate the updated machine-readable instructions (instruction validation 426). After the machine-readable instructions are validated, the framework development system can create a virtual environment for a driving scenario with recreation of the suspicious points that the machine-readable instructions are updated to address (vehicle simulation 428). In this simulation, the personnel can evaluate how a simulated autonomous vehicle with the updated instructions respond to the recreation of the suspicious points. Once the personnel deems the updated instructions addressed the suspicious points, the updated instructions can be deployed back to the autonomous vehicle (deploy updated instruction 430) for further testing with the autonomous vehicle in the vehicle active mode 404. In some instances, if the simulation shows that the update instructions did not address the suspicious points, the personnel may need to make further modifications to the machine-readable instructions (instruction update 424).

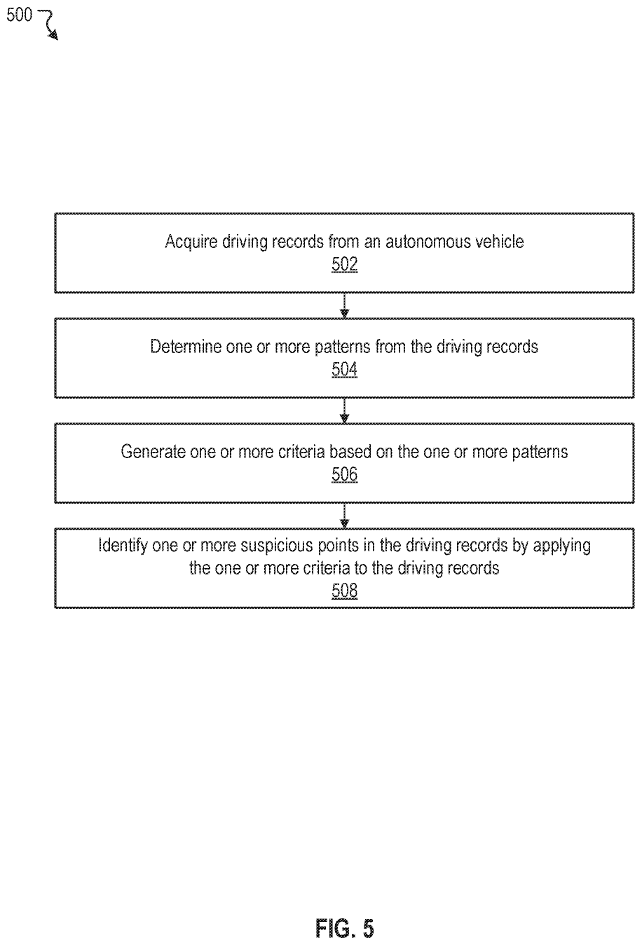

FIG. 5 illustrates an example method 500, according to an embodiment of the present disclosure. The method 500 may be implemented in various environments including, for example, the environment 300 of FIG. 3A. The operations of method 500 presented below are intended to be illustrative. Depending on the implementation, the example method 500 may include additional, fewer, or alternative steps performed in various orders or in parallel. The example method 500 may be implemented in various computing systems or devices including one or more processors.

At block 502, driving records from an autonomous vehicle are acquired. At block 504, one or more pattern are determined from the driving records. At block 506, one or more criteria are generated based on the one or more patterns. At block 508, one or more suspicious points in the driving records are identified by applying the one or more criteria to the driving records.

### Hardware Implementation

The techniques described herein are implemented by one or more special-purpose computing devices. The special-purpose computing devices may be hard-wired to perform the techniques, or may include circuitry or digital electronic devices such as one or more application-specific integrated circuits (ASICs) or field programmable gate arrays (FPGAs) that are persistently programmed to perform the techniques, or may include one or more hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, server computer systems, portable computer systems, handheld devices, networking devices or any other device or combination of devices that incorporate hard-wired and/or program logic to implement the techniques.

Computing device(s) are generally controlled and coordinated by operating system software, such as iOS, Android, Chrome OS, Windows XP, Windows Vista, Windows 7, Windows 8, Windows Server, Windows CE, Unix, Linux, SunOS, Solaris, iOS, Blackberry OS, VxWorks, or other compatible operating systems. In other embodiments, the computing device may be controlled by a proprietary operating system. Conventional operating systems control and schedule computer processes for execution, perform memory management, provide file system, networking, I/O services, and provide a user interface functionality, such as a graphical user interface (“GUI”), among other things.

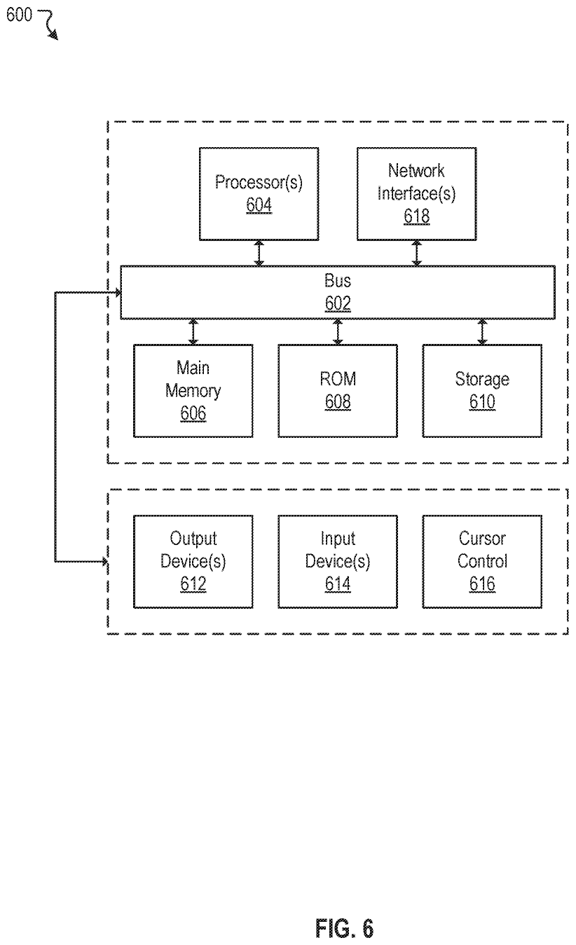

FIG. 6 is a block diagram that illustrates a computer system 600 upon which any of the embodiments described herein may be implemented. The computer system 600 includes a bus 602 or other communication mechanism for communicating information, one or more hardware processors 604 coupled with bus 602 for processing information. Hardware processor(s) 604 may be, for example, one or more general purpose microprocessors.

The computer system 600 also includes a main memory 606, such as a random access memory (RAM), cache and/or other dynamic storage devices, coupled to bus 602 for storing information and instructions to be executed by processor 604. Main memory 606 also may be used for storing temporary variables or other intermediate information during execution of instructions to be executed by processor 604. Such instructions, when stored in storage media accessible to processor 604, render computer system 600 into a special-purpose machine that is customized to perform the operations specified in the instructions.

The computer system 600 further includes a read only memory (ROM) 608 or other static storage device coupled to bus 602 for storing static information and instructions for processor 604. A storage device 610, such as a magnetic disk, optical disk, or USB thumb drive (Flash drive), etc., is provided and coupled to bus 602 for storing information and instructions.

The computer system 600 may be coupled via bus 602 to a display 612, such as a cathode ray tube (CRT) or LCD display (or touch screen), for displaying information to a computer user. An input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane. In some embodiments, the same direction information and command selections as cursor control may be implemented via receiving touches on a touch screen without a cursor.

The computing system 600 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “module,” as used herein, refers to logic embodied in hardware or firmware, or to a collection of software instructions, possibly having entry and exit points, written in a programming language, such as, for example, Java, C or C++. A software module may be compiled and linked into an executable program, installed in a dynamic link library, or may be written in an interpreted programming language such as, for example, BASIC, Perl, or Python. It will be appreciated that software modules may be callable from other modules or from themselves, and/or may be invoked in response to detected events or interrupts. Software modules configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware modules may be comprised of connected logic units, such as gates and flip-flops, and/or may be comprised of programmable units, such as programmable gate arrays or processors. The modules or computing device functionality described herein are preferably implemented as software modules, but may be represented in hardware or firmware. Generally, the modules described herein refer to logical modules that may be combined with other modules or divided into sub-modules despite their physical organization or storage.

The computer system 600 may implement the techniques described herein using customized hard-wired logic, one or more ASICs or FPGAs, firmware and/or program logic which in combination with the computer system causes or programs computer system 600 to be a special-purpose machine. According to one embodiment, the techniques herein are performed by computer system 600 in response to processor(s) 604 executing one or more sequences of one or more instructions contained in main memory 606. Such instructions may be read into main memory 606 from another storage medium, such as storage device 610. Execution of the sequences of instructions contained in main memory 606 causes processor(s) 604 to perform the process steps described herein. In alternative embodiments, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 610. Volatile media includes dynamic memory, such as main memory 606. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 602. Transmission media can also take the form of acoustic or light waves, such as those generated during radio-wave and infra-red data communications.

Various forms of media may be involved in carrying one or more sequences of one or more instructions to processor 604 for execution. For example, the instructions may initially be carried on a magnetic disk or solid state drive of a remote computer. The remote computer can load the instructions into its dynamic memory and send the instructions over a telephone line using a modem. A modem local to computer system 600 can receive the data on the telephone line and use an infra-red transmitter to convert the data to an infra-red signal. An infra-red detector can receive the data carried in the infra-red signal and appropriate circuitry can place the data on bus 602. Bus 602 carries the data to main memory 606, from which processor 604 retrieves and executes the instructions. The instructions received by main memory 606 may retrieves and executes the instructions. The instructions received by main memory 606 may optionally be stored on storage device 610 either before or after execution by processor 604.

The computer system 600 also includes a communication interface 618 coupled to bus 602. Communication interface 618 provides a two-way data communication coupling to one or more network links that are connected to one or more local networks. For example, communication interface 618 may be an integrated services digital network (ISDN) card, cable modem, satellite modem, or a modem to provide a data communication connection to a corresponding type of telephone line. As another example, communication interface 618 may be a local area network (LAN) card to provide a data communication connection to a compatible LAN (or WAN component to communicated with a WAN). Wireless links may also be implemented. In any such implementation, communication interface 618 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world wide packet data communication network now commonly referred to as the “Internet”. Local network and Internet both use electrical, electromagnetic or optical signals that carry digital data streams. The signals through the various networks and the signals on network link and through communication interface 618, which carry the digital data to and from computer system 600, are example forms of transmission media.

The computer system 600 can send messages and receive data, including program code, through the network(s), network link and communication interface 618. In the Internet example, a server might transmit a requested code for an application program through the Internet, the ISP, the local network and the communication interface 618.

The received code may be executed by processor 604 as it is received, and/or stored in storage device 610, or other non-volatile storage for later execution.

Each of the processes, methods, and algorithms described in the preceding sections may be embodied in, and fully or partially automated by, code modules executed by one or more computer systems or computer processors comprising computer hardware. The processes and algorithms may be implemented partially or wholly in application-specific circuitry.

The various features and processes described above may be used independently of one another, or may be combined in various ways. All possible combinations and sub-combinations are intended to fall within the scope of this disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed example embodiments. The example systems and components described herein may be configured differently than described. For example, elements may be added to, removed from, or rearranged compared to the disclosed example embodiments.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Any process descriptions, elements, or blocks in the flow diagrams described herein and/or depicted in the attached figures should be understood as potentially representing modules, segments, or portions of code which include one or more executable instructions for implementing specific logical functions or steps in the process. Alternate implementations are included within the scope of the embodiments described herein in which elements or functions may be deleted, executed out of order from that shown or discussed, including substantially concurrently or in reverse order, depending on the functionality involved, as would be understood by those skilled in the art.

It should be emphasized that many variations and modifications may be made to the above-described embodiments, the elements of which are to be understood as being among other acceptable examples. All such modifications and variations are intended to be included herein within the scope of this disclosure. The foregoing description details certain embodiments of the invention. It will be appreciated, however, that no matter how detailed the foregoing appears in text, the invention can be practiced in many ways. As is also stated above, it should be noted that the use of particular terminology when describing certain features or aspects of the invention should not be taken to imply that the terminology is being re-defined herein to be restricted to including any specific characteristics of the features or aspects of the invention with which that terminology is associated. The scope of the invention should therefore be construed in accordance with the appended claims and any equivalents thereof.

### Engines, Components, and Logic

Certain embodiments are described herein as including logic or a number of components, engines, or mechanisms. Engines may constitute either software engines (e.g., code embodied on a machine-readable medium) or hardware engines. A “hardware engine” is a tangible unit capable of performing certain operations and may be configured or arranged in a certain physical manner. In various example embodiments, one or more computer systems (e.g., a standalone computer system, a client computer system, or a server computer system) or one or more hardware engines of a computer system (e.g., a processor or a group of processors) may be configured by software (e.g., an application or application portion) as a hardware engine that operates to perform certain operations as described herein.

In some embodiments, a hardware engine may be implemented mechanically, electronically, or any suitable combination thereof. For example, a hardware engine may include dedicated circuitry or logic that is permanently configured to perform certain operations. For example, a hardware engine may be a special-purpose processor, such as a Field-Programmable Gate Array (FPGA) or an Application Specific Integrated Circuit (ASIC). A hardware engine may also include programmable logic or circuitry that is temporarily configured by software to perform certain operations. For example, a hardware engine may include software executed by a general-purpose processor or other programmable processor. Once configured by such software, hardware engines become specific machines (or specific components of a machine) uniquely tailored to perform the configured functions and are no longer general-purpose processors. It will be appreciated that the decision to implement a hardware engine mechanically, in dedicated and permanently configured circuitry, or in temporarily configured circuitry (e.g., configured by software) may be driven by cost and time considerations.

Accordingly, the phrase “hardware engine” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented engine” refers to a hardware engine. Considering embodiments in which hardware engines are temporarily configured (e.g., programmed), each of the hardware engines need not be configured or instantiated at any one instance in time. For example, where a hardware engine comprises a general-purpose processor configured by software to become a special-purpose processor, the general-purpose processor may be configured as respectively different special-purpose processors (e.g., comprising different hardware engines) at different times. Software accordingly configures a particular processor or processors, for example, to constitute a particular hardware engine at one instance of time and to constitute a different hardware engine at a different instance of time.

Hardware engines can provide information to, and receive information from, other hardware engines. Accordingly, the described hardware engines may be regarded as being communicatively coupled. Where multiple hardware engines exist contemporaneously, communications may be achieved through signal transmission (e.g., over appropriate circuits and buses) between or among two or more of the hardware engines. In embodiments in which multiple hardware engines are configured or instantiated at different times, communications between such hardware engines may be achieved, for example, through the storage and retrieval of information in memory structures to which the multiple hardware engines have access. For example, one hardware engine may perform an operation and store the output of that operation in a memory device to which it is communicatively coupled. A further hardware engine may then, at a later time, access the memory device to retrieve and process the stored output. Hardware engines may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented engines that operate to perform one or more operations or functions described herein. As used herein, “processor-implemented engine” refers to a hardware engine implemented using one or more processors.

Similarly, the methods described herein may be at least partially processor-implemented, with a particular processor or processors being an example of hardware. For example, at least some of the operations of a method may be performed by one or more processors or processor-implemented engines. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

The performance of certain of the operations may be distributed among the processors, not only residing within a single machine, but deployed across a number of machines. In some example embodiments, the processors or processor-implemented engines may be located in a single geographic location (e.g., within a home environment, an office environment, or a server farm). In other example embodiments, the processors or processor-implemented engines may be distributed across a number of geographic locations.

### Language

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the subject matter has been described with reference to specific example embodiments, various modifications and changes may be made to these embodiments without departing from the broader scope of embodiments of the present disclosure. Such embodiments of the subject matter may be referred to herein, individually or collectively, by the term “invention” merely for convenience and without intending to voluntarily limit the scope of this application to any single disclosure or concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

It will be appreciated that an “engine,” “system,” “data store,” and/or “database” may comprise software, hardware, firmware, and/or circuitry. In one example, one or more software programs comprising instructions capable of being executable by a processor may perform one or more of the functions of the engines, data stores, databases, or systems described herein. In another example, circuitry may perform the same or similar functions. Alternative embodiments may comprise more, less, or functionally equivalent engines, systems, data stores, or databases, and still be within the scope of present embodiments. For example, the functionality of the various systems, engines, data stores, and/or databases may be combined or divided differently.

“Open source” software is defined herein to be source code that allows distribution as source code as well as compiled form, with a well-publicized and indexed means of obtaining the source, optionally with a license that allows modifications and derived works.

The data stores described herein may be any suitable structure (e.g., an active database, a relational database, a self-referential database, a table, a matrix, an array, a flat file, a documented-oriented storage system, a non-relational No-SQL system, and the like), and may be cloud-based or otherwise.

As used herein, the term “or” may be construed in either an inclusive or exclusive sense. Moreover, plural instances may be provided for resources, operations, or structures described herein as a single instance. Additionally, boundaries between various resources, operations, engines, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Although the invention has been described in detail for the purpose of illustration based on what is currently considered to be the most practical and preferred implementations, it is to be understood that such detail is solely for that purpose and that the invention is not limited to the disclosed implementations, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

1. A computer-implemented method for identifying suspicious points in data comprising:
acquiring driving records from an autonomous vehicle;
determining one or more patterns from the driving records;
generating one or more criteria based on the one or more patterns; and
identifying one or more suspicious points in the driving records by applying the one or more criteria to the driving records.

2. The computer-implemented method of claim 1, further comprising:
retrieving data in the driving records corresponding to the one or more suspicious points; and
simulating the one or more suspicious points in a virtual environment, with a simulated autonomous vehicle, based on the data in the driving records.

3. The computer-implemented method of claim 1, wherein the driving records include data from at least one of light detection and ranging systems, radar systems, or camera systems of the autonomous vehicle.

4. The computer-implemented method of claim 1, wherein the driving records include data from at least one of location, speed, acceleration, rotation angle, throttle pedal percentage, brake pedal percentage, steering angle, trajectory planned, or obstacle perceived data from the autonomous vehicle.

5. The computer-implemented method of claim 1, wherein acquiring the driving records from the autonomous vehicle further comprises:
acquiring the driving records hourly, daily, weekly, bi-weekly, monthly, or at an end of a driving session from the autonomous vehicle.

6. The computer-implemented method of claim 1, wherein determining the one or more patterns from the driving records further comprises:
identifying the one or more patterns from the driving records by utilizing regression analysis; and
identifying the one or more patterns from the driving records by utilizing statistical analysis.

7. The computer-implemented method of claim 1, wherein generating the one or more criteria based on the one or more patterns further comprises:
generating the one or more criteria based on upper limit values of the one or more patterns.

8. The computer-implemented method of claim 1, wherein generating the one or more criteria based on the one or more patterns further comprises:
applying a tolerance to upper limit values of the one or more patterns.

9. The computer-implemented method of claim 1, wherein identifying the one or more suspicious points in the driving records by applying the one or more criteria further comprises:
aggregating the driving records acquired from the autonomous vehicle;
identifying data points in the aggregated driving records that satisfy the one or more criteria; and
labeling the data points as the one or more suspicious points.

10. The computer-implemented method of claim 2, wherein retrieving the data in the driving records corresponding to the one or more suspicious points further comprises:
receiving a user selection of a time frame to encapsulate the data in the driving records centered about the one or more suspicious points; and
retrieving the encapsulated data from the driving record corresponding to the time frame.

11. The computer-implemented method of claim 10, wherein the time frame to encapsulate the data is a default time frame.

12. The computer-implemented method of claim 10, wherein the user selection of the time frame to encapsulate the data includes any increments of seconds, minutes, and hours.

13. A system for identifying suspicious data comprising:
one or more processors; and
a memory storing instructions that, when executed by the one or more processor, cause the system to perform:
acquiring driving records from an autonomous vehicle;
determining one or more patterns from the driving records;
generating one or more criteria based on the one or more patterns; and
identifying one or more suspicious points in the driving records by applying the one or more criteria to the driving records.

14. The system of claim 13, wherein the memory storing instructions causes the system to further perform:
retrieving data in the driving records corresponding to the one or more suspicious points; and
simulating the one or more suspicious points in a virtual environment, with a simulated autonomous vehicle, based on the data in the driving records.

15. The system of claim 13, wherein the driving records include data from at least one of light detection and ranging systems, radar systems, or camera systems of the autonomous vehicle.

16. The system of claim 13, wherein the driving records include data from at least one of location, speed, acceleration, rotation angle, throttle pedal percentage, brake pedal percentage, steering angle, trajectory planned, or obstacle perceived data from the autonomous vehicle.

17. A non-transitory computer readable medium comprising instructions that, when executed, cause one or more processors to perform:
acquiring driving records from an autonomous vehicle;
determining one or more patterns from the driving records;
generating one or more criteria based on the one or more patterns; and
identifying one or more suspicious points in the driving records by applying the one or more criteria to the driving records.

18. The non-transitory computer readable medium of claim 17, wherein the instructions further cause the one or more processors to perform:
retrieving data in the driving records corresponding to the one or more suspicious points; and
simulating the one or more suspicious points in a virtual environment, with a simulated autonomous vehicle, based on the data in the driving records.

19. The non-transitory computer readable medium of claim 17, wherein the driving records include data from at least one of light detection and ranging systems, radar systems, or camera systems of the autonomous vehicle.

20. The non-transitory computer readable medium of claim 17, wherein the driving records include data from at least one of location, speed, acceleration, rotation angle, throttle pedal percentage, brake pedal percentage, steering angle, trajectory planned, or obstacle perceived data from the autonomous vehicle.
